(19) United States
(12) Patent Application Publication
(10) Pub. No.: US 2026/0187212 A1
(43) Pub. Date: Jul. 2, 2026

(54) IDENTITY AUTHENTICATION USING MULTIPLE IMAGE MODALITIES

(71) Applicant: Meta Platforms Technologies, LLC, Menlo Park, CA (US)

(72) Inventors: Khushi Gupta, Seattle, WA (US); Prithviraj Dhar, San Francisco, CA (US); Anton Kalachev, Burlingame, CA (US); Ryan Peter Begley, Orinda, CA (US); Gary King, Los Altos, CA (US); Rakesh Ranjan, Mountain View, CA (US); Asad Sheth, San Jose, CA (US)

(21) Appl. No.: 19/005,939

(22) Filed: Dec. 30, 2024

(51) Int. Cl. G06F 21/32; G02B 27/01; G06V 40/16

(52) U.S. Cl. CPC G06F 21/32; G02B 27/017; G06V 40/172

(57) ABSTRACT

As disclosed herein, a computer-implemented method for detecting avatar impersonation is provided. The computer-implemented method may include generating, from a first type of image data associated with a first user, a digital representation of the first user. The computer-implemented method may include generating, from a second type of image data associated with a second user, a digital representation of the second user. The computer-implemented method may include determining a similarity score associated with a degree of correspondence between the digital representations. The computer-implemented method may include determining, based on the similarity score, whether an identity of the first user matches an identity of the second user. The computer-implemented method may include allowing, based on determining the identity of the first user matches an identity of the second user, an access to an asset associated with the first user. A system and a non-transitory computer-readable storage medium are also disclosed.

### BACKGROUND

### Field

The present disclosure generally relates to identity authentication. More particularly, the present disclosure relates to verifying an identity of an individual using multiple image modalities.

### Related Art

The proliferation of digital technologies and online services has increased the need for secure and reliable identity authentication techniques. Traditional authentication mechanisms, such as passwords and personal identification numbers (PINs), have proven insufficient in safeguarding sensitive information and preventing unauthorized access. As a result, biometric authentication methods, which rely on unique physical characteristics of an individual, have gained traction due to their potential for enhanced security and user convenience.

### SUMMARY

The subject disclosure provides for systems and methods for verifying an identity of an individual using multiple image modalities. As disclosed herein, an authorized user may have access to an asset (e.g., a system, a resource, a service), and a requesting user may attempt to gain access to the asset. To verify whether the authorized user is the same user as the requesting user, the identity of the authorized user may be compared to the identity of the requesting user. The identity of the authorized user may be determined using an image (e.g., a red, green, blue (RGB) image) of the authorized user. The identity of the requesting user may be determined using an image (e.g., a near-infrared (NIR) image) of the requesting user. The image modality of the image of the authorized user may differ from the image modality of the image of the requesting user. In some embodiments, if the identity of the authorized user matches the identity of the requesting user, then the requesting user may be granted access to the asset. In some embodiments, if the identity of the authorized user does not match the identity of the requesting user, then the requesting user may be denied access to the asset.

According to certain aspects of the present disclosure, a computer-implemented method is provided. The computer-implemented method may include generating, from a first type of image data associated with a first user, a first digital representation of the first user. The computer-implemented method may include generating, from a second type of image data associated with a second user, a second digital representation of the second user. The computer-implemented method may include determining a similarity score associated with a degree of correspondence between the first and the second digital representations. The computer-implemented method may include determining, based on the similarity score, whether an identity of the first user matches an identity of the second user. The computer-implemented method may include allowing, based on determining the identity of the first user matches the identity of the second user, an access to an asset associated with the first user.

According to another aspect of the present disclosure, a system is provided. The system may include one or more processors. The system may include a memory storing instructions that, when executed by the one or more processors, cause the system to perform operations. The operations may include generating, from a first type of image data associated with a first user, a first digital representation of the first user. The operations may include generating, from a second type of image data associated with a second user, a second digital representation of the second user. The operations may include determining a similarity score associated with a degree of correspondence between the first and the second digital representations. The operations may include determining, based on the similarity score, whether an identity of the first user matches an identity of the second user. The operations may include allowing, based on determining the identity of the first user matches the identity of the second user, an access to an asset associated with the first user.

According to yet other aspects of the present disclosure, a non-transitory computer-readable storage medium storing instructions encoded thereon that, when executed by a processor, cause the processor to perform operations, is provided. The operations may include receiving, from at least one sensor including at least one camera associated with a first client device of a first user, a first type of image data including true-color image data. The operations may include receiving, from at least one sensor including at least one camera associated with a second client device of a second user, a second type of image data including false-color image data. At least one of the first client device and the second client device may include a head-mounted display. The operations may include generating, from the first type of image data associated with the first user, a first digital representation of the first user. The operations may include generating, from the second type of image data associated with the second user, a second digital representation of the second user. The operations may include determining a similarity score associated with a degree of correspondence between the first and the second digital representations. The operations may include determining, based on the similarity score, whether an identity of the first user matches an identity of the second user. The operations may include allowing, based on determining the identity of the first user matches the identity of the second user, an access to a three-dimensional model of the first user displayed via the first client device or the second client device. Determining the identity of the first user matches the identity of the second user may include determining the similarity score satisfies a similarity threshold.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 illustrates an example environment suitable for identity authentication using multiple image modalities, according to some embodiments;

FIG. 2 is a block diagram illustrating details of an example client device and an example server from the environment of FIG. 1, according to some embodiments;

FIG. 3 includes a flowchart illustrating an example process for generating a concatenated image of a user using multiple images highlighting one or more physical features of the user, according to some embodiments;

FIG. 4 is a block diagram illustrating example stages for training an ML model to extract a unique representation of an identity of an individual from one or more images of the individual, according to some embodiments;

FIG. 5 is a flowchart illustrating operations in a method for identity authentication using multiple image modalities, according to some embodiments; and

FIG. 6 is a block diagram illustrating an exemplary computer system with which client devices, and the methods and processes in FIGS. 3 and 5 may be implemented, according to some embodiments.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below is intended as a description of various implementations and is not intended to represent the only implementations in which the subject technology may be practiced. As those skilled in the art would realize, the described implementations may be modified in various different ways, all without departing from the scope of the present disclosure. Accordingly, the drawings and description are to be regarded as illustrative in nature and not restrictive. Those skilled in the art may realize other elements that, although not specifically described herein, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

### General Overview

The proliferation of digital technologies and online services has increased the need for secure and reliable identity authentication techniques. Traditional authentication mechanisms, such as passwords and personal identification numbers (PINs), have proven insufficient in safeguarding sensitive information and preventing unauthorized access. As a result, biometric authentication methods, which rely on unique physical characteristics of an individual, have gained traction due to their potential for enhanced security and user convenience.

Current image-based biometric systems often utilize a single image modality—such as red, green, blue (RGB) or near-infrared (NIR)—to capture and analyze physical features. While these systems have demonstrated effectiveness in various applications, they are not without limitations. For example, RGB facial recognition systems may be vulnerable to spoofing attacks using photographs or masks and may struggle in varying lighting conditions. Infrared (IR) systems, while effective in low-light environments, may fail to accurately capture details in bright conditions or with users who have specific physical attributes.

The integration of multiple image modalities presents an opportunity to enhance the robustness and effectiveness of biometric authentication systems. By capturing and analyzing physical features from multiple image modalities, this invention aims to provide a comprehensive solution that improves accuracy, security, and user experience.

By way of non-limiting examples, a multi-modal identity authorization system may compare RGB images and infrared images to ensure only authorized users may unlock a personal computing device; may conduct a financial transaction; may enter an entertainment venue or professional conference; may retrieve patient information; may create or recover an online account; may secure government services; or may access sensitive areas, such as laboratories, data centers, or secure facilities.

By way of further non-limiting example, a multi-modal identity authorization system may compare RGB images and infrared images to detect avatar impersonation. The use of avatars in extended reality (XR) applications—including virtual reality (VR), augmented reality (AR), and mixed reality (MR) applications—has become increasingly prevalent, allowing users to represent themselves in digital environments such as virtual meetings and video games. The control of an avatar is typically intended to be exclusive to the user the avatar represents. This exclusivity ensures the actions and interactions within the XR environment accurately reflect the intentions and behaviors of all users. Instances where avatars are controlled by unauthorized users can disrupt the integrity and security of such environments.

Herein, avatar impersonation may refer to the act of controlling or attempting to control an avatar, which may refer to a digital representation or graphical image that stands in for a user in an XR environment, without authorization. Avatar impersonation may involve a first user pretending to be a second user by driving the avatar of the second user in an XR environment. Avatar impersonation may occur in various contexts, including video gaming, virtual meetings, social networks, and other online platforms where users interact with each other or with the XR environment through avatars. Key aspects of avatar impersonation may include the following: unauthorized access, whereby an impersonator may gain control of an avatar without the consent of the legitimate owner of the avatar; deception, whereby an impersonator may use the avatar to deceive other users in an XR environment, making the other users believe that the other users are interacting with the legitimate owner; and potential consequences, which may include privacy violations, security breaches, and misuse of the identity of an avatar owner for malicious purposes. The following paragraphs provide several non-limiting examples of avatar impersonation across various contexts, including gaming; social media and virtual communities; professional environments; educational platforms; and healthcare and telemedicine.

Gaming: A first player may gain unauthorized access to a gaming account of a second player and may use the avatar of the second player to participate in games, potentially ruining the reputation or ranking of the second player. Or, a first player may use the avatar of a second player, who may be a trusted friend of a third player, to deceive the third player out of in-game currency or items by pretending to be the second player.

Social Media and Virtual Communities: A first individual may use an avatar of a second individual in a virtual world or social media platform to create a fake persona, tricking a third user into forming a relationship or sharing personal information. Or, a first individual may take control of an avatar of a popular influencer to post misleading or harmful content, potentially damaging the reputation of the popular influencer and spreading false information. Or, a first individual may take control of an avatar of a second individual in a virtual marketplace to conduct unauthorized transactions, leading to financial loss for the second individual.

Professional Environments: An unauthorized individual may gain access to an avatar of an employee in a virtual meeting, using the avatar of the employee to listen in on confidential discussions or steal proprietary information. Or, an impersonator may use an avatar of an employee to communicate with clients or partners, potentially making unauthorized decisions or commitments. Or, an individual may impersonate an avatar of an executive to request sensitive information or authorize financial transactions, deceiving employees into compliance. Or, an individual may use an avatar of an invitee to attend a virtual conference, gaining access to events and networks in which the individual is not authorized to participate.

Educational Platforms: A student may use an avatar of a classmate to attend virtual classes or take online exams, potentially gaining unfair academic advantages. Or, an individual may impersonate an avatar of a fellow student to send harassing messages to other students.

Healthcare and Telemedicine: An individual may impersonate an avatar of a doctor during a telemedicine consultation, providing incorrect medical advice or prescriptions to a patient, which may harm the health of the patient. Or, an impersonator may use an avatar of a patient to book appointments with healthcare providers, accessing medical services or consultations under false pretenses.

In XR environments where avatars represent users, determining whether the identity of an avatar driver (i.e., the person or user controlling or attempting to control the avatar) matches the identity of the avatar owner (i.e., the person or user represented by the avatar) is paramount to preventing impersonation, fraud, and breaches of privacy. Current methods for verifying the identity of an avatar driver often rely on static identifiers like passwords or facial recognition, which may be inadequate in scenarios where dynamic verification is required, such as during active gaming sessions or virtual meetings. Moreover, current methods utilizing image data for identity verification often rely on a single image modality (e.g., true-color images, such as red-green-blue (RGB) images, or false-color images, such as near-infrared (NIR) images), which may constrain the effectiveness of a method by the inherent limitations of the image modality. For example, RGB images may capture color information and general appearance, but RGB images may not provide sufficient detail for precise recognition of physical landmarks or subtle differences in texture. NIR or infrared (IR) images may capture unique biological features such as vein patterns or thermal characteristics, but NIR or IR images may provide color information and may have limited spatial resolution compared to RGB images. Therefore, there is a pressing need for a robust and reliable system that can, using multi-modal image data, accurately detect avatar impersonation in real-time.

As disclosed herein, novel systems and methods represent a significant advancement in the field of identity authentication by leveraging artificial intelligence (AI) technologies and access to real-time, multi-modal image data to compare image data associated with an authorized user to image data associated with a requesting user and to determine whether an identity of the authorized user matches an identity of the requesting user.

According to some embodiments, one or more images may be captured of an authorized user. The authorized user may have access to an asset (e.g., a system, a resource, a service). Prior to or during access to the asset, one or more images may be captured of a requesting user or a current user. The image modality (type) of the one or more images of the authorized user may differ from the image modality of the one or more images of the requesting or current user. The one or more images of the requesting or current user may be provided to a first machine learning (ML) model trained using multi-modal image data, and the one or more images of the requesting or current user may be provided to a second ML model trained using multi-modal image data. The first ML model may provide as output an image embedding corresponding to the one or more images of the authorized user, and the second ML model may provide as output an image embedding corresponding to the one or more images of the requesting or current user. A similarity score representing a degree of correspondence between the image embedding output by the first ML model and the image embedding output by the second ML model may be computed. Based on the similarity score, it may be determined whether the identity of the authorized user matches the identity of the requesting or current user.

In some embodiments, if the identity of the authorized user matches the identity of the requesting or current user, then access to or control of the asset may be granted to or persisted for the requesting or current user. In some embodiments, if the identity of the authorized user does not match the identity of the requesting or current user, then access to or control of the asset may be denied to or canceled for the requesting or current user.

According to an exemplary embodiment, an extended reality (XR) application running on a device of a user (e.g., a mobile phone or a head-mounted display (HMD)) may capture one or more images of the user (e.g., with one or more external or world-facing cameras of a mobile phone or an HMD) to generate an avatar of the user in an XR environment. Prior to or during use of the avatar, the XR application may capture one or more images of the avatar driver (e.g., with one or more internal or user-facing cameras of a mobile phone or an HMD). The image modality (type) of the one or more images of the user (i.e., avatar owner) may differ from the image modality of the one or more images of the avatar driver. The XR application may provide the one or more images of the user to a first machine learning (ML) model trained using multi-modal image data, and the XR application may provide the one or more images of the avatar driver to a second ML model trained using multi-modal image data. The XR application may receive as output from the first ML model an image embedding corresponding to the one or more images of the avatar owner, and may receive as output from the second ML model an image embedding corresponding to the one or more images of the avatar driver. The XR application may compute a similarity score representing a degree of correspondence between the image embedding output by the first ML model and the image embedding output by the second ML model. Based on the similarity score, the XR application may determine whether the identity of the avatar owner matches the identity of the avatar driver.

In some embodiments, if the XR application determines the identity of the avatar owner matches the identity of the avatar driver, then the XR application may allow the avatar driver access to or control of the avatar. In some embodiments, if the XR application determines the identity of the avatar owner does not match the identity of the avatar driver, then the XR application may deny the avatar driver access to or control of the avatar.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments may be practiced without these specific details. In other instances, well known structures and devices are shown in block diagram form in order to facilitate a description thereof. The intention is to cover all modifications, equivalents, and alternatives consistent with the claimed subject matter.

### Example System Architecture

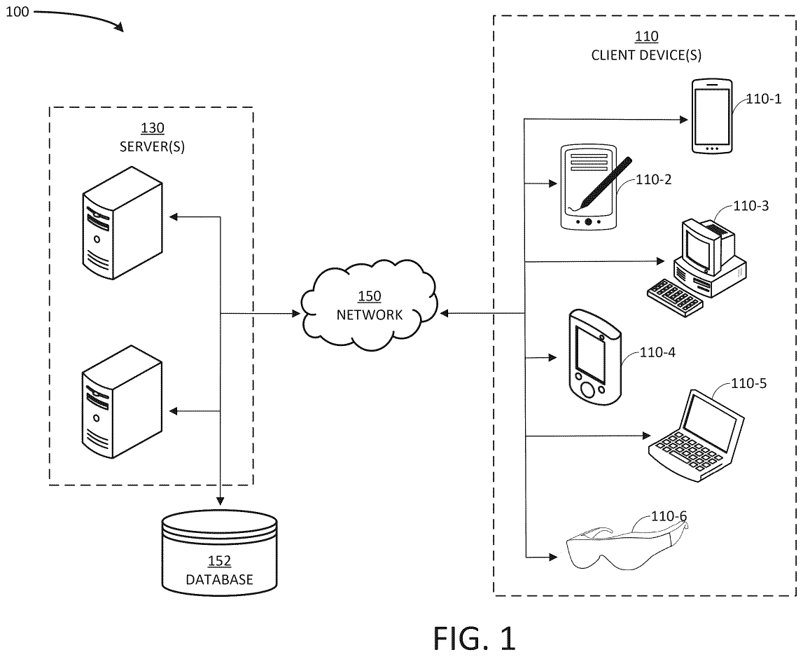

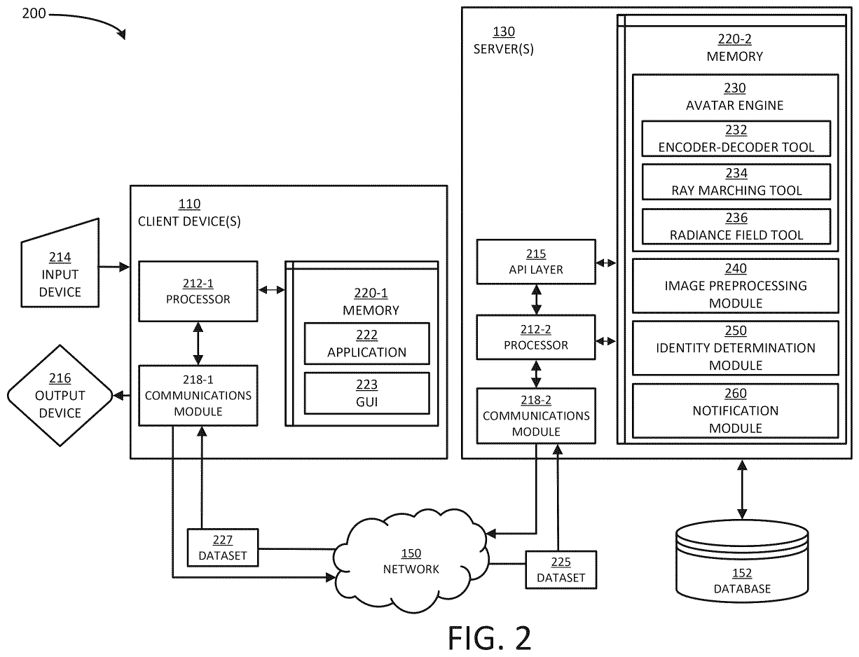

FIG. 1 illustrates an example environment 100 suitable for identity authentication using multiple image modalities, according to some embodiments. Environment 100 may include server(s) 130 communicatively coupled with client device(s) 110 and database 152 over a network 150. One of the server(s) 130 may be configured to host a memory including instructions which, when executed by a processor, cause server(s) 130 to perform at least some of the steps in methods as disclosed herein. In some embodiments, the processor may be configured to control a graphical user interface (GUI) for the user of one of client device(s) 110 accessing an avatar engine (e.g., avatar engine 230, FIG. 2)—which may include an encoder-decoder tool (e.g., encoder-decoder tool 232, FIG. 2), a ray marching tool (e.g., ray marching tool 234, FIG. 2), or a radiance field tool (e.g., radiance field tool 236, FIG. 2)—an image preprocessing module (e.g., image preprocessing module 240, FIG. 2), an identity determination module (e.g., identity determination module 250, FIG. 2), or a notification module (e.g., notification module 260, FIG. 2) with an application (e.g., application 222, FIG. 2). Accordingly, the processor may include a dashboard tool, configured to display components and graphic results to the user via a GUI (e.g., GUI 223, FIG. 2). For purposes of load balancing, multiple servers of server(s) 130 may host memories including instructions to one or more processors, and multiple servers of server(s) 130 may host a history log and database 152 including multiple training archives for the avatar engine, the image preprocessing module, the identity determination module, or the notification module. Moreover, in some embodiments, multiple users of client device(s) 110 may access the same avatar engine, image preprocessing module, identity determination module, or notification module. In some embodiments, a single user with a single client device (e.g., one of client device(s) 110) may provide images and data (e.g., text) to train one or more artificial intelligence (AI) models (e.g., machine learning (ML) models) running in parallel in one or more server(s) 130. Accordingly, client device(s) 110 and server(s) 130 may communicate with each other via network 150 and resources located therein, such as data in database 152.

Server(s) 130 may include any device having an appropriate processor, memory, and communications capability for the avatar engine, the image preprocessing module, the identity determination module, or the notification module. Any of the avatar engine, the image preprocessing module, the identity determination module, or the notification module may be accessible by client device(s) 110 over network 150.

Client device(s) 110 may include any one of a laptop computer 110-5, a desktop computer 110-3, or a mobile device, such as a smartphone 110-1, a palm device 110-4, or a tablet device 110-2. In some embodiments, client device(s) 110 may include a headset or other wearable device 110-6 (e.g., an extended reality headset or smart glass, including a virtual reality (VR), augmented reality (AR), or mixed reality (MR) headset or smart glass), such that at least one participant may be running an extended reality (XR) application installed therein.

Network 150 may include, for example, any one or more of a local area network (LAN), a wide area network (WAN), the Internet, and the like. Further, network 150 may include, but is not limited to, any one or more of the following network topologies, including a bus network, a star network, a ring network, a mesh network, a star-bus network, tree or hierarchical network, and the like.

A user may own or operate client device(s) 110 that may include a smartphone device 110-1 (e.g., an IPHONE® device, an ANDROID® device, a BLACKBERRY® device, or any other mobile computing device conforming to a smartphone form). Smartphone device 110-1 may be a cellular device capable of connecting to a network 150 via a cell system using cellular signals. In some embodiments and in some cases, smartphone device 110-1 may additionally or alternatively use Wi-Fi or other networking technologies to connect to network 150. Smartphone device 110-1 may execute a client, Web browser, or other local application to access server(s) 130.

A user may own or operate client device(s) 110 that may include a tablet device 110-2 (e.g., an IPAD® tablet device, an ANDROID® tablet device, a KINDLE FIRE® tablet device, or any other mobile computing device conforming to a tablet form). Tablet device 110-2 may be a Wi-Fi device capable of connecting to a network 150 via a Wi-Fi access point using Wi-Fi signals. In some embodiments and in some cases, tablet device 110-2 may additionally or alternatively use cellular or other networking technologies to connect to network 150. Tablet device 110-2 may execute a client, Web browser, or other local application to access server(s) 130.

The user may own or operate client device(s) 110 that may include a laptop computer 110-5 (e.g., a MAC OS® device, WINDOWS® device, LINUX® device, or other computer device running another operating system). Laptop computer 110-5 may be an Ethernet device capable of connecting to a network 150 via an Ethernet connection. In some embodiments and in some cases, laptop computer 110-5 may additionally or alternatively use cellular, Wi-Fi, or other networking technologies to connect to network 150. Laptop computer 110-5 may execute a client, Web browser, or other local application to access server(s) 130.

FIG. 2 is a block diagram 200 illustrating details of example client device(s) 110 and example server(s) 130 from the environment of FIG. 1, according to some embodiments. Client device(s) 110 and server(s) 130 may be communicatively coupled over network 150 via respective communications modules 218-1 and 218-2 (hereinafter, collectively referred to as “communications modules 218”). Communications modules 218 may be configured to interface with network 150 to send and receive information, such as requests, responses, messages, or commands to other devices on the network in the form of datasets 225 and 227. Communications modules 218 may be, for example, modems or Ethernet cards, and may include radio hardware and software for wireless communications (e.g., via electromagnetic radiation, such as radiofrequency (RF), near field communications (NFC), Wi-Fi, or Bluetooth radio technology). Client device(s) 110 may be coupled with input device 214 and with output device 216. Input device 214 may include a keyboard, a mouse, a pointer, a touchscreen, a microphone, a joystick, a virtual joystick, and the like. In some embodiments, input device 214 may include cameras, microphones, and sensors, such as touch sensors, acoustic sensors, inertial motion units (IMUs), and other sensors configured to provide input data to an XR headset. For example, in some embodiments, input device 214 may include an eye-tracking device to detect the position of a pupil of a user in an XR headset. Likewise, output device 216 may include a display and a speaker with which the customer may retrieve results from client device(s) 110. Client device(s) 110 may also include processor 212-1, configured to execute instructions stored in memory 220-1, and to cause client device(s) 110 to perform at least some of the steps in methods consistent with the present disclosure. Memory 220-1 may further include application 222 and graphical user interface (GUI) 223, configured to run in client device(s) 110 and couple with input device 214 and output device 216. Application 222 may be downloaded by the user from server(s) 130 or may be hosted by server(s) 130. In some embodiments, client device(s) 110 may be an XR headset and application 222 may be an extended reality application. In some embodiments, client device(s) 110 may be a mobile phone used to collect a video or picture and upload to server(s) 130 using a video or image collection application (e.g., application 222), to store in database 152. In some embodiments, application 222 may run on any operating system (OS) installed in client device(s) 110. In some embodiments, application 222 may run out of a Web browser, installed in client device(s) 110.

Dataset 227 may include multiple messages and multimedia files. A user of client device(s) 110 may store at least some of the messages and data content in dataset 227 in memory 220-1. In some embodiments, a user may upload, with client device(s) 110, dataset 225 onto server(s) 130. Database 152 may store data and files associated with application 222 (e.g., one or more of datasets 225 and 227).

Server(s) 130 may include application programming interface (API) layer 215, which may control application 222 in each of client device(s) 110. Server(s) 130 may also include a memory 220-2 storing instructions which, when executed by processor 212-2, cause server(s) 130 to perform at least partially one or more operations in methods consistent with the present disclosure.

Processors 212-1 and 212-2 and memories 220-1 and 220-2 will be collectively referred to, hereinafter, as “processors 212” and “memories 220,” respectively.

Processors 212 may be configured to execute instructions stored in memories 220. In some embodiments, memory 220-2 may include an avatar engine 230—which may include encoder-decoder tool 232, ray marching tool 234, radiance field tool 236—image preprocessing module 240, identity determination module 250, and notification module 260. Avatar engine 230, image preprocessing module 240, identity determination module 250, or notification module 260 may share or provide features or resources to GUI 223, including multiple tools associated with training and using an avatar rendering model for extended reality applications (e.g., application 222). A user may access avatar engine 230, image preprocessing module 240, identity determination module 250, or notification module 260 through application 222, installed in a memory 220-1 of client device(s) 110. Accordingly, application 222, including GUI 223, may be installed by server(s) 130 and perform scripts and other routines provided by server(s) 130 through any one of multiple tools. Execution of application 222 may be controlled by processor 212-1.

Avatar engine 230 may be configured to create, store, update, or maintain an avatar model (e.g., a two-dimensional or three-dimensional avatar model), as disclosed herein. Avatar engine 230 may capture comprehensive data about a user (e.g., high-resolution RGB images, near-infrared (NIR) images, or other biometric data such as facial landmarks, voice patterns, and behavioral biometrics). Sensors and devices capable of capturing detailed biometric information may be utilized to ensure accuracy and completeness. The captured data may undergo processing to extract key features and characteristics of a user. The processing may include facial recognition algorithms to identify and map facial landmarks, or algorithms for extracting behavioral biometrics like gestures and voice patterns. Data encoding techniques may be applied to convert the extracted features into a standardized format suitable for storage and comparison, which may ensure an avatar model is compact, secure, and optimized for efficient retrieval and processing. An avatar may be designed to be comprehensive and invariant to normal variations in appearance and behavior while reflecting the unique attributes that distinguish a user.

An avatar may be securely stored in a centralized database or a distributed storage system. Security measures such as encryption, access controls, and data integrity checks may be implemented to protect the integrity and confidentiality of the biometric data of an avatar owner. Regular updates and maintenance may ensure an avatar remains current and accurate, reflecting any changes in the appearance or biometric characteristics of an avatar owner over time.

In some embodiments, an avatar may serve as a reference point for comparison during avatar initiation or use. Real-time data (e.g., images, behavioral biometrics) captured from an avatar driver may be compared with the avatar intermittently or regularly. By way of non-limiting example, intermittent comparisons may be conducted upon a user opening an application (e.g., application 222) featuring the avatar, upon the detection of a user handling a client device (e.g., picking up a mobile phone, or donning an HMD) hosting an application (e.g., application 222) featuring the avatar, or upon a user requesting control of the avatar. Handling of a client device may be detected using, for example, inertial sensors or proximity sensors. By way of non-limiting example, regular comparisons may be conducted while a user is driving the avatar. The comparison results may be analyzed to determine a likelihood of avatar impersonation. Any discrepancies or mismatches may trigger alerts or corrective actions, such as suspending avatar control or notifying administrators.

Avatar engine 230 may include encoder-decoder tool 232, ray marching tool 234, and radiance field tool 236. Encoder-decoder tool 232 may collect one or more input images of a subject (e.g., a full-body or full-face portrait image of a subject, or multiple images of a body of a subject, or portions thereof, from different views) and extract features (e.g., pixel-aligned features) to condition radiance field tool 236 via a ray marching procedure in ray marching tool 234. In some embodiments, avatar engine 230 may generate novel views of unseen subjects from one or more sample images processed by encoder-decoder tool 232. In some embodiments, encoder-decoder tool 232 may include a shallow (e.g., including multiple one- or two-node layers) convolutional network. In some embodiments, radiance field tool 236 may convert a three-dimensional location and features into color and opacity fields that may be projected in any desired direction of view.

In some embodiments, avatar engine 230 may access one or more artificial intelligence (AI) models (e.g., machine learning (ML) models) stored in database 152. Database 152 may include training archives and other data files that may be used by avatar engine 230 in the training of an AI model, according to the input of a user through application 222. Moreover, in some embodiments, at least one or more training archives or AI models may be stored in any one of memories 220, and a user may access the at least one or more training archives or AI models through application 222.

Avatar engine 230 may include algorithms trained for the specific purposes of the engines and tools included therein. The algorithms may include machine learning or artificial intelligence (AI) algorithms making use of any linear or non-linear algorithm, such as a neural network algorithm or a multivariate regression algorithm. In some embodiments, an ML model may include a neural network (NN), a convolutional neural network (CNN), a generative adversarial neural network (GAN), a deep reinforcement learning (DRL) algorithm, a deep recurrent neural network (DRNN), or a classic ML algorithm such as random forest, k-nearest neighbor (KNN) algorithm, k-means clustering algorithms, or any combination thereof. More generally, an ML model may include any ML model involving a training step and an optimization step. In some embodiments, database 152 may include a training archive to modify coefficients according to a desired outcome of an ML model. Accordingly, in some embodiments, avatar engine 230 may be configured to access training database 152 to retrieve documents and archives as inputs for an ML model. In some embodiments, avatar engine 230, the tools contained therein, and at least part of database 152 may be hosted in a different server that is accessible by server(s) 130 or client device(s) 110.

Image preprocessing module 240 may be configured to prepare or enhance images of a user captured for subsequent analysis and identity authentication. Image preprocessing module 240 may acquire images of an authorized user (e.g., an avatar owner) and a requesting or current user (e.g., an avatar driver). In some embodiments, images of an authorized user may be captured prior to access of an asset (e.g., during a user scanning step of an avatar generation process, using one or more external or world-facing cameras of a mobile phone or an HMD). In some embodiments, images of an authorized user may be retrieved from a database (e.g., database 152) storing the images. In some embodiments, images of an authorized user may be captured in real time with one or more cameras (e.g., one or more internal or user-facing cameras of a mobile phone or an HMD) integrated into a device hosting an application featuring, hosting, or providing the asset (e.g., application 222). The image modality (type) of the images of the authorized user may differ from the image modality of images of the requesting or current user. By way of non-limiting example, image modalities may include true-color (also known as natural-color) images, which may refer to images that accurately depict colors as the colors would be perceived by the human eye in natural daylight (e.g., RGB images). By way of non-limiting example, image modalities may include false-color (also known as pseudo-color) images, which may refer to images that do not depict colors as the colors would be perceived by the human eye in natural daylight (e.g., near-infrared (NIR) images). False-color images may be created using solely the visual spectrum, or false-color images may be created at least partially from electromagnetic radiation (EM) data outside the visual spectrum (e.g., infrared, ultraviolet, or X-ray).

Upon image acquisition, image preprocessing module 240 may perform quality assessments to evaluate the clarity, resolution, or overall quality of the images. Techniques such as image denoising, contrast enhancement, and sharpening filters may be applied to improve image quality and ensure that subsequent analysis yields accurate results. Correction of distortions or artifacts caused by lens aberrations, motion blur, or environmental factors (e.g., lighting variations) may also be conducted to improve image quality and ensure that subsequent analysis yields accurate results.

In some embodiments, image preprocessing module 240 may employ physical feature (e.g., facial feature) detection algorithms to locate and extract physical (e.g., facial, non-facial) regions within the captured images. Physical landmarks (e.g., eyes, nose, mouth, leg, arm) or physical contour may be identified to facilitate precise alignment and normalization of orientation and scale. Alignment techniques may adjust the position, focus, zoom level, or rotation of images to a standardized pose, reducing variability and ensuring consistency in feature extraction and comparison.

In some embodiments, a single image of an authorized user may be provided to a first ML model trained as described herein to generate an image embedding corresponding to the single image of the authorized user, and a single image of a requesting or current user may be provided to a second ML model trained as described herein to generate an image embedding corresponding to the single image of the requesting or current user. The first ML model may be different from the second ML model. The single image of the authorized user and the single image of the requesting or current user may be selected or paired such that the images include corresponding content or context. For example, a single image including a head portrait of the authorized user may be selected or paired to correspond to a single image including a head portrait of the requesting or current user.

In some embodiments, multiple images of an authorized user may be provided to a first ML model trained as described herein to generate an image embedding corresponding to the multiple images of the authorized user, and multiple images of a requesting or current user may be provided to a second ML model trained as described herein to generate an image embedding corresponding to multiple images of the requesting or current user. The first ML model may be different from the second ML model. The multiple images of the authorized user and the multiple images of the requesting or current user may be selected or paired such that the images include corresponding content or context. For example, multiple images including different views of a head of the authorized user may be selected or paired to correspond to multiple images including different views of a head of the requesting or current user.

In some embodiments, image preprocessing module 240 may generate, from one or more images of a user, one or more images highlighting one or more physical features of the user (e.g., left eye, right eye, nose, mouth, leg, arm). In further aspects, image preprocessing module 240 may concatenate multiple images highlighting one or more physical features of the user into a single image according to a predefined arrangement. By way of non-limiting example, a concatenated image may include four images: an image of a left eye, an image of a right eye, an image of a left side of a mouth, and an image of a right side of a mouth. The concatenated image may arrange the four images in four quadrants of the concatenated image. An upper-left quadrant may include the image of the right eye, an upper-right quadrant may include the image of the left eye, a lower-left quadrant may include the image of the right side of a mouth, and a lower-right quadrant may include the image of the left side of the mouth. In some embodiments, a concatenated image of an authorized user may be provided to a first ML model trained as described herein to generate an image embedding corresponding to the concatenated image of the authorized user, and a concatenated image of a requesting or current user may be provided to a second ML model trained as described herein to generate an image embedding corresponding to the concatenated image of the requesting or current user. The first ML model may be different from the second ML model. The concatenated image of the authorized user and the concatenated image of the requesting or current user may be selected or paired such that the concatenated images include corresponding content or context.

Identity determination module 250 may be configured to determine an identity of a user and to verify whether an identity of an authorized user matches an identity of a requesting or current user. Identity determination module 250 may use one or more ML models trained as described herein to extract discriminative features (identity information) from preprocessed images. Discriminative features may include texture descriptors, local binary patterns, histogram of gradients (HOG), or deep learning-based representations extracted from convolutional neural networks (CNNs). In some embodiments, behavioral biometrics such as facial expressions, eye movements, or head gestures may also be extracted. Extracted features or biometric data may be encoded into image embeddings including a standardized format suitable for comparison or storage. Encoding techniques may ensure that an image embedding (i.e., a digital representation of a user or a user identity) is compact, secure, and optimized for efficient retrieval and processing during identity verification.

In some embodiments, metadata such as timestamps, location information, and contextual data related to avatar interactions may be annotated to provide additional context for analysis (e.g., comparison of an image embedding associated with an authorized user and an image embedding associated with a requesting or current user). In some embodiments, identity determination module 250 may integrate additional biometric data sources, such as fingerprint scans, iris scans, or physiological signals (e.g., heartbeat, gait analysis).

Identity determination module 250 may compare an image embedding associated with an authorized user and an image embedding associated with a requesting or current user. Matching algorithms, including ML models and pattern recognition techniques, may assess a similarity score associated with a degree of correspondence between the image embeddings. Identity determination module 250 may determine whether the similarity score satisfies (e.g., meets, exceeds, extends beyond) a similarity threshold. The similarity threshold may refer to a degree (or, level, magnitude, or the like) of similarity or resemblance required between at least two image embeddings for the at least two image embeddings to be considered sufficiently similar or a match. If a similarity score satisfies a similarity threshold, then an identity of an authorized user may be considered sufficiently similar to or a match with an identity of a requesting or current user (e.g., avatar impersonation is not detected). If a similarity score fails to satisfy a similarity threshold, then an identity of an authorized user may be considered insufficiently similar to or not a match with an identity of a requesting or current user (e.g., avatar impersonation is detected).

Notification module 260 may be configured to trigger appropriate alerts or responses upon a determination that an identity of an authorized user does not match an identity of a requesting or current user. Thresholds and decision rules may be configured based on user preferences or security policies. Decision rules may define conditions that, when met, trigger alerts indicating potential impersonation attempts. Notification module 260 may generate real-time alerts including notifications to users (e.g., authorized users (such as avatar owners), requesting or current users (such as avatar drivers), system administrators (such as administrators of an avatar application), or other users) via dashboard displays, email, SMS, or other communication channels. In some embodiments, notification module 260 may initiate additional identity verification steps. By way of non-limiting examples, additional identity verification steps may include the following:

Multifactor Authentication (MFA): Notification module 260 may require an authorized user to authenticate using multiple factors, such as knowledge factors (e.g., challenge questions, passwords, or personal identification numbers (PINs) known only to the authorized user), possession factors (e.g., one-time passcodes sent to a registered mobile device or generated by an authentication application), or location factors (e.g., geolocation verification to ensure the authorized user is accessing the system from an authorized location).

Biometric Re-authentication: Notification module 260 may prompt the authorized user to undergo a re-authentication process using biometric data. This could involve capturing additional images (e.g., RGB images, NIR images) or recording additional behavioral biometrics (e.g., voice sample, typing dynamics) for comparison against the initial biometric data captured during asset access.

Temporal Verification: Notification module 260 may verify the timing and frequency of asset access to detect unusual patterns or discrepancies. For example, notification module 260 may compare current asset access patterns with historical data to ensure consistency in access patterns and flag sudden changes in interaction frequency or timing that may indicate unauthorized access or unusual behavior.

Session Monitoring and Review: Notification module 260 may initiate real-time session monitoring of asset access to observe ongoing behavior and activities. This may allow for immediate intervention if suspicious actions or deviations from normal behavior are detected during access.

Manual Verification by Administrators: Notification module 260 may enable administrators to manually review flagged incidents or alerts raised by the system. Administrators may conduct visual verification by comparing images of a requesting or current user with images of an authorized user or reviewing activity logs to determine the legitimacy of the identity of the requesting or current user.

Biometric Challenge-Response Mechanisms: Notification module 260 may implement challenge-response mechanisms based on biometric data. For example, notification module 260 may prompt a requesting or current user to perform specific actions (e.g., facial expressions, gestures) that are difficult for imposters to replicate convincingly, or notification module 260 may use biometric puzzles or tests that require the requesting or current user to demonstrate knowledge or capability consistent with the profile of the authorized user.

Suspension of Access Privileges: Notification module 260 may temporarily suspend or restrict access to sensitive functionalities associated with an asset (e.g., functionalities within an extended reality environment) until identity authentication is successfully completed, which may help prevent further unauthorized actions while verification steps are being conducted.

Integration with Incident Response Protocols: Notification module 260 may integrate verification steps with broader incident response protocols to ensure a coordinated and effective response to security incidents related to unauthorized asset access. Notification module 260 may document incident details, actions taken, and outcomes for post-incident analysis and improvement of detection and response procedures. Comprehensive logging of detected incidents, alert triggers, and response actions may ensure traceability and auditability. Reporting capabilities may provide stakeholders with insights into system performance, trends, and areas for improvement.

In some embodiments, notification module 260 may prioritize alerts based on severity and potential impact on security. Critical alerts that indicate high-confidence impersonation attempts or security breaches may receive immediate attention and escalation to designated users (e.g., asset owner, system administrator, or other users). Escalation procedures may ensure that appropriate response actions are taken promptly to mitigate risks and prevent further unauthorized activities.

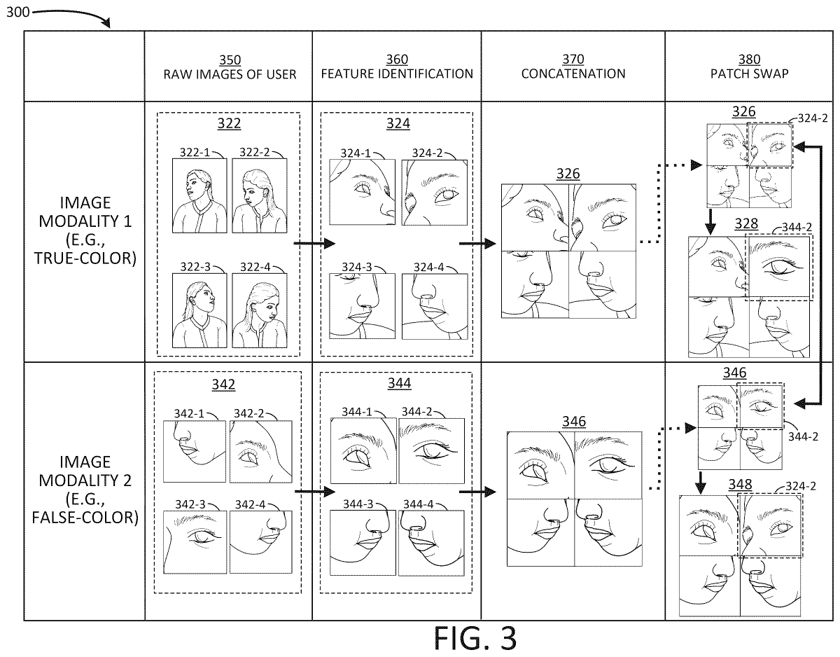

FIG. 3 includes a flowchart illustrating an example process 300 for generating a concatenated image of a user using multiple images highlighting one or more physical features of the user, according to some embodiments. Operations in example process 300 may be performed at least partially by a processor executing instructions stored in a memory, wherein the processor and the memory are part of a client device as disclosed herein (e.g., memories 220, processors 212, and client device(s) 110). In yet other embodiments, at least one or more of the operations in a process consistent with example process 300 may be performed by a processor executing instructions stored in a memory wherein at least one of the processor and the memory are remotely located in a cloud server and a database, and the client device is communicatively coupled to the cloud server via a communications module coupled to a network (e.g., server(s) 130, database 152, communications modules 218, and network 150). In some embodiments, the server may include an avatar engine-which may include an encoder-decoder tool, a ray marching tool, or a radiance field tool—an image preprocessing module, an identity determination module, or a notification module (e.g., avatar engine 230, encoder-decoder tool 232, ray marching tool 234, radiance field tool 236, image preprocessing module 240, identity determination module 250, or notification module 260). In some embodiments, processes consistent with the present disclosure may include at least one or more steps from process 300 performed in a different order, simultaneously, quasi-simultaneously, or overlapping in time.

At operation 350, raw images of a user (e.g., an authorized user, such as an avatar owner, or a requesting or current user, such as an avatar driver) may be acquired. In some embodiments, images of a user may be captured prior to access to an asset. By way of non-limiting example, images of a user, such as raw images 322, may be captured during a user scanning step of an avatar generation process, using one or more external or world-facing cameras of a mobile phone or an HMD. Raw images 322 may include raw image 322-1, raw image 322-2, raw image 322-3, and raw image 322-4, which capture a head of a user positioned at different angles. In some embodiments, images of a user may be retrieved from a database (e.g., database 152) storing the images. In some embodiments, images of a user may be captured in real time with one or more cameras integrated into a device hosting an application associated with an asset (e.g., application 222). By way of non-limiting example, images of a user, such as raw images 342, may be captured by one or more internal or user-facing cameras of a mobile phone or an HMD. Raw images 342 may include raw image 342-1, raw image 342-2, raw image 342-3, and raw image 342-4, which may capture different regions of a head of a user. The image modality (type) of raw images 322 may differ from the image modality of raw images 342. By way of non-limiting example, an image modality of raw images 322 may include true-color images (e.g., RGB images). By way of non-limiting example, an image modality of raw images 342 may include false-color images (e.g., NIR images).

At operation 360, one or more images highlighting one or more physical features of a user, such as feature images 324 or feature images 344, may be generated from one or more raw images of the user, such as raw images 322 and raw images 342, respectively. Feature images 324 may include feature image 324-1, which highlights a right eye of the user, feature image 324-2, which highlights a left eye of the user, feature image 324-3, which highlights a right side of a mouth of the user, and feature image 324-4, which highlights a left side of a mouth of the user. Feature images 344 may include feature image 344-1, which highlights a right eye of the user, feature image 344-2, which highlights a left eye of the user, feature image 344-3, which highlights a right side of a mouth of the user, and feature image 344-4, which highlights a left side of a mouth of the user. Feature images 324 and feature images 344 may include all or a portion of at least one image of raw images 322 and raw images 342, respectively. For example, feature image 324-1, which highlights a right eye of the user, may be based on raw image 322-3. As shown, feature image 324-1 excludes the clothing, neck, and jaw regions of raw image 322-3. In some embodiments, each image highlighting one or more physical features of a user may be aligned or normalized for orientation and scale, such that images highlighting a particular physical feature of a user (e.g., eye, nose, and/or mouth) may include a similar orientation and scale. For example, feature image 324-4 and 344-4, which highlight a left side of a mouth of a user, show the mouth of the user at a similar orientation and at a similar scale.

At operation 370, multiple images highlighting one or more physical features of the user, such as feature images 324 and feature images 344, may be concatenated into a single image, such as concatenated image 326 and concatenated image 346, respectively, according to a predefined arrangement. For example, the upper-left quadrants of concatenated images 326 and 346 include an image of a right eye (feature image 324-1 and feature image 344-1, respectively). The upper-right quadrants of concatenated images 326 and 346 include images of a left eye (feature image 324-2 and feature image 344-2, respectively). The lower-left quadrant of concatenated images 326 and 346 include images of the right side of a mouth (feature image 324-3 and feature image 344-3, respectively). The lower-right quadrants of concatenated images 326 and 346 include images of the left side of a mouth (feature image 324-4 and feature image 344-4).

In some embodiments, a concatenated image of a user may be provided to an ML model trained as described herein to generate an image embedding corresponding to the concatenated image. For example, concatenated image 326 may be provided to a first ML model, and concatenated image 346 may be provided to a second ML model. The first ML model may be different from the second ML model. As disclosed herein, concatenated or non-concatenated images may be used for Stage 1 or Stage 2 of training an ML model or for implementation of the ML model.

In some embodiments, at operation 380, a corresponding patch (e.g., region, portion, sub-image, or the like) of two corresponding (paired) concatenated or non-concatenated images may be swapped to generate a training image for Stage 1 of training an ML model as described herein. For example, as shown, the upper-right quadrant of concatenated image 326, which includes feature image 324-2, may be swapped with the upper-right quadrant of concatenated image 346, which includes feature image 344-2, to generate training image 328 and training image 348. Training image 328 and training image 348, which include different image modalities, may correspond to the same user in order to train an ML model to accept multiple image modalities and to extract user identity information from an image including any of the multiple image modalities.

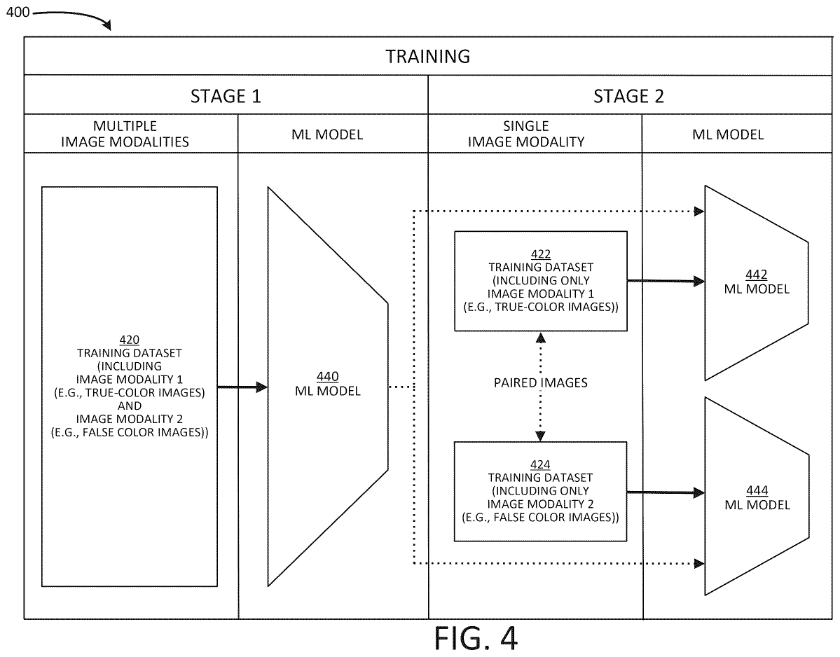

FIG. 4 is a block diagram 400 illustrating example stages for training one or more ML models to extract a unique representation of an identity of an individual from one or more images of the individual, according to some embodiments. The unique representation may include an embedding vector that represents the identity of the individual. The one or more images of the individual may include multiple image modalities (e.g., RGB, NIR).

At Stage 1, training dataset 420 may be generated for ML model 440. Training dataset 420 may include multiple images of multiple users. The multiple images of each user may include multiple image modalities (e.g., RGB, NIR). Each image may be labeled with an identity of a user the image portrays. In some embodiments, the multiple images of each user may include concatenated or non-concatenated images as described herein, wherein a corresponding patch (e.g., region, portion, sub-image, or the like) of pairs of images of a user may be swapped, and wherein the pairs of images may include different image modalities (e.g., RGB and NIR).

In some embodiments, a loss function may include triplet loss, which may be utilized to minimize the distance between embeddings for the same user and to maximize the distance between embeddings for different users. For example, consider User X and User Y. Multiple RGB images RGB_{X}, including RGB_{X-1} and RGB_{X-2}, may be captured or generated for User X. Multiple RGB images RGB_{Y}, including RGB_{Y-1}, may be captured or generated for User Y. In some embodiments, an RGB image may include more than fifty percent RGB image data.

A triplet may be created by defining the following: RGB_{X-1} as RGB anchor input A_{RGB} (i.e., a reference input); RGB_{X-2} as RGB positive input P_{RGB} (i.e., an input similar to the reference input); and RGB_{Y-1} as RGB negative input N_{RGB} (i.e., an input dissimilar to the reference input). An RGB triplet loss for Stage 1 may therefore be expressed as:

$${Loss}_{{RGB}_{1}} = max ( 0 , d ( f ( {A}_{RGB} ) , f ( {P}_{RGB} ) ) - d ( f ( {A}_{RGB} ) , f ( {N}_{RGB} ) ) + α ) , \qquad ( 1 )$$

where f(A_{RGB}) is the embedding output from ML model 440 for input RGB_{X-1}, f(P_{RGB}) is the embedding output from ML model 440 for input RGB_{X-2}, f(N_{RGB}) is the embedding output from ML model 440 for input RGB_{Y-1}, and α is a margin parameter that ensures f(N_{RGB}) is sufficiently farther from f(A_{RGB}) than f(P_{RGB}).

Multiple NIR images NIR_{X}, including NIR_{X-1} and NIR_{X-2}, may be captured or generated for User X. Multiple NIR images NIR_{Y}, including NIR_{Y-1}, may be captured or generated for User Y. In some embodiments, an NIR image may include more than fifty percent NIR image data.

A triplet may be created by defining the following: NIR_{X-1} as NIR anchor input A_{NIR} (i.e., a reference input); NIR_{X-2} as NIR positive input P_{NIR} (i.e., an input similar to the reference input); and NIR_{Y-1} as NIR negative input N_{NIR} (i.e., an input dissimilar to the reference input). An NIR triplet loss for Stage 1 may therefore be expressed as:

$${Loss}_{{NIR}_{1}} = max ( 0 , d ( f ( {A}_{NIR} ) , f ( {P}_{NIR} ) ) - d ( f ( {A}_{NIR} ) , f ( {N}_{NIR} ) ) + α ) , \qquad ( 2 )$$

where f(A_{NIR}) is the embedding output from ML model 440 for input NIR_{X-1}, f(P_{NIR}) is the embedding output from ML model 440 for input NIR_{X-2}, f(N_{NIR}) is the embedding output from ML model 440 for input NIR_{Y-1}, and α is a margin parameter that ensures f(N_{NIR}) is sufficiently farther from f(A_{NIR}) than f(P_{NIR}).

A total triplet loss for Stage 1 may therefore be expressed as:

$$L o s {s}_{{tot}_{1}} = L o s {s}_{R G {B}_{1}} + L o s {s}_{{NIR}_{1}} . \qquad ( 3 )$$

At Stage 2, training dataset 422 may be generated for ML model 442, and training dataset 424 may be generated for ML model 444. Training dataset 422 may include multiple images of multiple users, wherein the multiple images include a single image modality of the multiple image modalities used in training dataset 420. Training dataset 424 may include multiple images of multiple users, wherein the multiple images include a single image modality of the multiple image modalities used in training dataset 420, and wherein the image modality of training dataset 422 (e.g., RGB) is different from the image modality of training dataset 424 (e.g., NIR). ML model 442 and ML model 444 may include iterations of ML model 440 after ML model 440 has been trained using multi-modal image data in Stage 1. Each image of training datasets 422 and 424 may be labeled with an identity of a user the image portrays.

In some embodiments, a loss function may include triplet loss, which may be utilized to minimize the distance between embeddings for the same user and to maximize the distance between embeddings for different users. For example, consider User X and User Y. Multiple RGB images RGB_{X}, including RGB_{X-1} and RGB_{X-2}, may be captured or generated for User X. Multiple RGB images RGB_{Y}, including RGB_{Y-1}, may be captured or generated for User Y.

A triplet may be created by defining the following: RGB_{X-1} as RGB anchor input A_{RGB} (i.e., a reference input); RGB_{X-2} as RGB positive input P_{RGB} (i.e., an input similar to the reference input); and RGB_{Y-1} as RGB negative input N_{RGB} (i.e., an input dissimilar to the reference input). An RGB triplet loss for Stage 2 may therefore be expressed as:

$${Loss}_{{RGB}_{2}} = max ( 0 , d ( f ( {A}_{R G B} ) , f ( {P}_{R G B} ) ) - d ( f ( {A}_{R G B} ) , f ( {N}_{R G B} ) ) + α ) , \qquad ( 4 )$$

where f(A_{RGB}) is the embedding output from ML model 442 for input RGB_{X-1}, f(P_{RGB}) is the embedding output from ML model 442 for input RGB_{X-2}, f(N_{RGB}) is the embedding output from ML model 442 for input RGB_{Y-1}, and α is a margin parameter that ensures f(N_{RGB}) is sufficiently farther from f(A_{RGB}) than f(P_{RGB}).

Multiple NIR images NIR_{X}, including NIR_{X-1} and NIR_{X-2}, may be captured or generated for User X. Multiple NIR images NIR_{Y}, including NIR_{Y-1}, may be captured or generated for User Y.

A triplet may be created by defining the following: NIRₓ₋₁ as NIR anchor input A_{NIR} (i.e., a reference input); NIRₓ₋₂ as NIR positive input P_{NIR} (i.e., an input similar to the reference input); and NIR_{Y-1} as NIR negative input N_{NIR} (i.e., an input dissimilar to the reference input). An NIR triplet loss for Stage 2 may therefore be expressed as:

$${Loss}_{{NIR}_{2}} = max ( 0 , d ( f ( {A}_{NIR} ) , f ( {P}_{NIR} ) ) - d ( f ( {A}_{NIR} ) , f ( {N}_{NIR} ) ) + α ) , \qquad ( 5 )$$

where f(A_{NIR}) is the embedding output from ML model 444 for input NIR_{X-1}, f(P_{NIR}) is the embedding output from ML model 444 for input NIR_{X-2}, f(N_{NIR}) is the embedding output from ML model 444 for input NIR_{Y-1}, and α is a margin parameter that ensures f(N_{NIR}) is sufficiently farther from f(A_{NIR}) than f(P_{NIR}).

A total triplet loss for Stage 2 may therefore be expressed as:

$$L o s {s}_{{tot}_{2}} = L o s {s}_{R G {B}_{2}} + L o s {s}_{{NIR}_{2}} , \qquad ( 6 )$$

In some embodiments, a loss function may include a cross-modal triplet loss, which may be utilized for ML model 442 or ML model 444 to minimize the distance between embeddings for the same user and to maximize the distance between embeddings for different users. For example, consider User X and User Y. Multiple RGB images RGB_{X}, including RGB_{X-1} and RGB_{X-2}, may be captured or generated for User X. Multiple RGB images RGB_{Y}, including RGB_{Y-1} and RGB_{Y-2}, may be captured or generated for User Y. Multiple NIR images NIR_{X}, including NIR_{X-1} and NIR_{X-2}, may be captured or generated for User X. Multiple NIR images NIR_{Y}, including NIR_{Y-1} and NIR_{Y-2}, may be captured or generated for User Y.

A first cross-modal triplet may be created by defining the following: RGB_{X-1} as RGB anchor input A_{RGB} (i.e., a reference input); NIR_{X-2} as NIR positive input P_{NIR} (i.e., an input similar to the reference input); and NIR_{Y-1} as NIR negative input N_{NIR} (i.e., an input dissimilar to the reference input). A first cross-modal triplet loss may therefore be expressed as:

$$L o s {s}_{C {M}_{1}} = max ( 0 , d ( f ( {A}_{R G B} ) , f ( {P}_{NIR} ) ) - d ( f ( {A}_{R G B} ) , f ( {N}_{NIR} ) ) + α ) , \qquad ( 7 )$$

where f(A_{RGB}) is the embedding output from ML model 442 input RGB_{X-1}, f(P_{NIR}) is the embedding output from ML model 444 for input NIR_{X-2}, f(N_{NIR}) is the embedding output from ML model 444 for input NIR_{Y-1}, and α is a margin parameter that ensures f(N_{NIR}) is sufficiently farther from f(A_{RGB}) than f(P_{NIR}).

A second cross-modal triplet may be created by defining the following: NIR_{X-1} as NIR anchor input A_{NIR} (i.e., a reference input); RGB_{X-2} as RGB positive input P_{RGB} (i.e., an input similar to the reference input); and

$${Loss}_{{CM}_{2}} = max ( 0 , d ( f ( {A}_{NIR} ) , f ( {P}_{RGB} ) ) - d ( f ( {A}_{NIR} ) , f ( {N}_{RGN} ) ) + α ) , \qquad ( 8 )$$

where f(A_{NIR}) is the embedding output from ML model 444 for input NIR_{X-1}, f(P_{RGB}) is the embedding output from ML model 442 for input RGB_{X-2}, f(N_{RGB}) is the embedding output from ML model 442 for input RGB_{Y-1}, and α is a margin parameter that ensures f(N_{RGB}) is sufficiently farther from f(A_{NIR}) than f(P_{RGB}).

A total cross-modal triplet loss for Stage 2 may therefore be expressed as:

$${( {Loss}_{{tot}_{2}} )}_{CM} = {Loss}_{{CM}_{1}} + {Loss}_{{CM}_{2}} , \qquad ( 9 )$$

In some embodiments, feature mixup may be utilized to improve the results of LOSS_{RGB}_{₂} and LOSS_{NIR}_{₂}. For example, consider User X and User Y. Multiple RGB images RGB_{X}, including RGB_{X-1} and RGB_{X-2}, may be captured or generated for User X. Multiple RGB images RGB_{Y}, including RGB_{Y-1} and RGB_{Y-2}, may be captured or generated for User Y. Multiple NIR images NIR_{X}, including NIR_{X-1} and NIR_{X-2}, may be captured or generated for User X. Multiple NIR images NIR_{Y}, including NIR_{Y-1} and NIR_{Y-2}, may be captured or generated for User Y.

A first triplet may be created by defining the following: RGB_{X-1} as RGB anchor input A_{RGB} (i.e., a reference input); RGB_{X-2} as RGB positive input P_{RGB} (i.e., an input similar to the reference input); and RGB_{Y-1} as RGB negative input N_{RGB} (i.e., an input dissimilar to the reference input). A second triplet may be created by defining the following: NIRₓ₋₁ as NIR anchor input A_{NIR} (i.e., a reference input); NIR_{X-2} as NIR positive input P_{NIR} (i.e., an input similar to the reference input); and NIR_{Y-1} as NIR negative input N_{NIR} (i.e., an input dissimilar to the reference input).

A first linear combination and a second linear combination of an embedding output f(P_{RGB}) from ML model 442 for input RGB_{X-2} and of an embedding output f(P_{NIR}) from ML model 444 for input NIR_{X-2} may be expressed as:

$$f ( {P}_{{mix}_{1}} ) = ( ( 1 - λ ) * f ( {P}_{RGB} ) ) + ( λ * f ( {P}_{NIR} ) ) \qquad ( 10 )$$

$$and$$

$$f ( {P}_{{mix}_{2}} ) = ( ( 1 - λ ) * f ( {P}_{NIR} ) ) + ( λ * f ( {P}_{RGB} ) ) , \qquad ( 11 )$$

where f(P_{RGB}) is the embedding output from ML model 442 for input RGB_{X-2}, f(P_{NIR}) is the embedding output from ML model 444 for input NIR_{X-2}, and A is a mixing coefficient. In some embodiments, A may be a scalar value in the range [0.001, 0.100].

A first linear combination and a second linear combination of an embedding output f(N_{RGB}) from ML model 442 for input RGB_{Y-1} and of an embedding output f(N_{NIR}) from ML model 444 for input NIR_{Y-1} may be expressed as:

$$f ( {N}_{{mix}_{1}} ) = ( ( 1 - λ ) * f ( {N}_{RGB} ) ) + ( λ + f ( {N}_{NIR} ) ) \qquad ( 12 )$$

$$and$$

$$f ( {N}_{{mix}_{2}} ) = ( ( 1 - λ ) * f ( {N}_{NIR} ) ) + ( λ + f ( {N}_{RGB} ) ) , \qquad ( 13 )$$

where f(N_{RGB}) is the embedding output from ML model 442 for input RGB_{Y-1}, f(N_{NIR}) is the embedding output from ML model 444 for input NIR_{Y-1}, and A is a mixing coefficient. In some embodiments, A may be a scalar value in the range [0.001, 0.100].

An RGB triplet loss for Stage 2, using feature mixup, may therefore be expressed as:

$${( {Loss}_{{RGB}_{2}} )}_{mix} = max ( 0 , d ( f ( {A}_{RGB} ) , f ( {P}_{{mix}_{1}} ) ) - d ( f ( {A}_{RGB} ) , f ( {N}_{{mix}_{1}} ) ) + α ) , \qquad ( 14 )$$

where f(A_{RGB}) is the embedding output from ML model 442 for input RGB_{X-1}, and α is a margin parameter that ensures f(Nₘᵢₓ_{₁}) is sufficiently farther from f(A_{RGB}) than f(Pₘᵢₓ_{₁}).

An NIR triplet loss for Stage 2, using feature mixup, may therefore be expressed as:

$${( L o s {s}_{{NIR}_{2}} )}_{m i x} = max ( 0 , d ( f ( {A}_{NIR} ) , f ( {P}_{m i {x}_{2}} ) ) - d ( f ( {A}_{NIR} ) , f ( {N}_{m i {x}_{2}} ) ) + α ) , \qquad ( 15 )$$

where f(A_{NIR}) is the embedding output from ML model 444 for input NIR_{X-1}, and α is a margin parameter that ensures f(Nₘᵢₓ_{₂}) is sufficiently farther from f(A_{NIR}) than f(Pₘᵢₓ_{₂}).

A total triplet loss for Stage 2, using feature mixup, may therefore be expressed as:

$${( L o s {s}_{{tot}_{2}} )}_{m i x} = {( L o s {s}_{R G {B}_{2}} )}_{m i x} + {( L o s {s}_{{NIR}_{2}} )}_{m i x} , \qquad ( 16 )$$

In some aspects of the embodiments, the loss function may include a cross-modal triplet loss, which may be utilized for ML model 442 or ML model 444 to minimize the distance between embeddings for the same user and to maximize the distance between embeddings for different users.

A first cross-modal triplet may be created by defining the following: RGB_{X-1} as RGB anchor input A_{RGB} (i.e., a reference input); NIR_{X-2} as NIR positive input P_{NIR} (i.e., an input similar to the reference input); and NIR_{Y-1} as NIR negative input N_{NIR} (i.e., an input dissimilar to the reference input). A first cross-modal triplet loss may therefore be expressed as:

$${Loss}_{{CM}_{1}} = max ( 0 , d ( f ( {A}_{RGB} ) , f ( {P}_{NIR} ) ) - d ( f ( {A}_{RGB} ) , f ( {N}_{NIR} ) ) + α ) , \qquad ( 17 )$$

where f(A_{RGB}) is the embedding output from ML model 442 input RGB_{X-1}, f(P_{NIR}) is the embedding output from ML model 444 for input NIR_{X-2}, f(N_{NIR}) is the embedding output from ML model 444 for input NIR_{Y-1}, and α is a margin parameter that ensures f(N_{NIR}) is sufficiently farther from f(A_{RGB}) than f(P_{NIR}).

A second cross-modal triplet may be created by defining the following: NIR_{X-1} as NIR anchor input A_{NIR} (i.e., a reference input); RGB_{X-2} as RGB positive input P_{RGB} (i.e., an input similar to the reference input); and RGB_{Y-1} as RGB negative input N_{RGB} (i.e., an input dissimilar to the reference input). A second cross-modal triplet loss may therefore be expressed as:

$${Loss}_{{CM}_{2}} = max ( 0 , d ( f ( {A}_{NIR} ) , f ( {P}_{RGB} ) ) - d ( f ( {A}_{NIR} ) , f ( {N}_{RGB} ) ) + α ) , \qquad ( 18 )$$

where f(A_{NIR}) is the embedding output from ML model 444 for input NIR_{X-1}, f(P_{RGB}) is the embedding output from ML model 442 for input RGB_{X-2}, f(N_{RGB}) is the embedding output from ML model 442 for input RGB_{Y-1}, and α is a margin parameter that ensures f(N_{RGB}) is sufficiently farther from f(A_{NIR}) than f(P_{RGB}).

A total cross-modal triplet loss for Stage 2, using feature mixup, may therefore be expressed as:

$${( {Loss}_{{tot}_{2}} )}_{CM , mix} = {Loss}_{{CM}_{1}} + {Loss}_{{CM}_{2}} + ( β * {( {Loss}_{{RGB}_{2}} )}_{mix} ) + ( β * {( {Loss}_{{NIR}_{2}} )}_{mix} ) , \qquad ( 19 )$$

where β is a scalar value. In some embodiments, β may be 0.1.

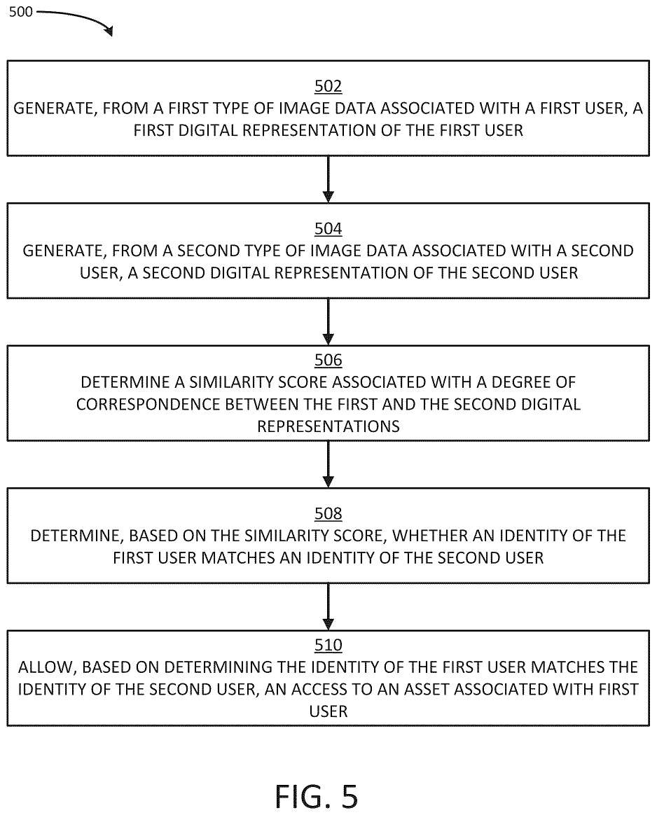

FIG. 5 is a flowchart illustrating operations in a method 500 for identity authentication using multiple image modalities, according to some embodiments. In some embodiments, processes as disclosed herein may be performed at least partially by a processor executing instructions stored in a memory, wherein the processor and the memory are part of a client device as disclosed herein (e.g., memories 220, processors 212, and client device(s) 110). In yet other embodiments, at least one or more of the operations in a process consistent with method 500 may be performed by a processor executing instructions stored in a memory wherein at least one of the processor and the memory are remotely located in a cloud server and a database, and the client device is communicatively coupled to the cloud server via a communications module coupled to a network (e.g., server(s) 130, database 152, communications modules 218, and network 150). In some embodiments, the server may include an avatar engine—which may include an encoder-decoder tool, a ray marching tool, or a radiance field tool—an image preprocessing module, an identity determination module, or a notification module (e.g., avatar engine 230, encoder-decoder tool 232, ray marching tool 234, radiance field tool 236, image preprocessing module 240, identity determination module 250, or notification module 260). In some embodiments, processes consistent with the present disclosure may include at least one or more steps from process 300 performed in a different order, simultaneously, quasi-simultaneously, or overlapping in time.

Operation 502 may include generating, from a first type of image data associated with a first user, a first digital representation of the first user. In some embodiments, the first digital representation may include an embedding associated with an identity of the first user. In further aspects of the embodiments, operation 502 may include receiving, from at least one sensor including at least one camera associated with a first client device of the first user, the first type of image data. In some embodiments, generating the first digital representation may include identifying, based on the first type of image data, one or more physical features of the first user. In some embodiments, generating the first digital representation may include determining, based on the one or more physical features of the first user, an identity of the first user.

Operation 504 may include generating, from a second type of image data associated with a second user, a second digital representation of the second user. In some embodiments, the second digital representation may include an embedding associated with an identity of the second user. In further aspects of the embodiments, operation 504 may include receiving, from at least one sensor including at least one camera associated with a second client device of the second user, the second type of image data. In some aspects of the embodiments, the first client device may be the same as the second client device, and at least one of the first client device and the second client device may include a head-mounted display. In some aspects of the embodiments, the first client device may be different from the second client device, and at least one of the first client device and the second client device may include a head-mounted display. In some embodiments, the first type of image data may include at least one image of at least one physical feature of the first user. In some embodiments, the second type of image data may include at least one image of at least one physical feature of the second user. In some embodiments, the first type of image data may be different from the second type of image data. In some embodiments, the first type of image data may include true-color image data. In some embodiments, the second type of image data may include false-color image data. In some embodiments, generating the second digital representation may include identifying, based on the second type of image data, one or more physical features of the second user. In some embodiments, generating the second digital representation may include determining, based on the one or more physical features of the second user, an identity of the second user.

Operation 506 may include determining a similarity score associated with a degree of correspondence between the first and the second digital representations. Operation 508 may include determining, based on the similarity score, whether an identity of the first user matches an identity of the second user.

Operation 510 may include allowing, based on determining the identity of the first user matches the identity of the second user, an access to an asset associated with the first user. In some embodiments, determining the identity of the first user matches the identity of the second user may include determining the similarity score satisfies a similarity threshold. In further aspects of the embodiments, operation 510 may include denying, based on determining the identity of the first user differs from the identity of the second user, the access to the asset associated with the first user. In some aspects of the embodiments, determining the identity of the first user differs from the identity of the second user may include determining the similarity score fails to satisfy a similarity threshold. In some embodiments, the asset associated with the first user may include a three-dimensional model of the first user displayed via a first client device of the first user or a second client device of the second user.

### Hardware Overview

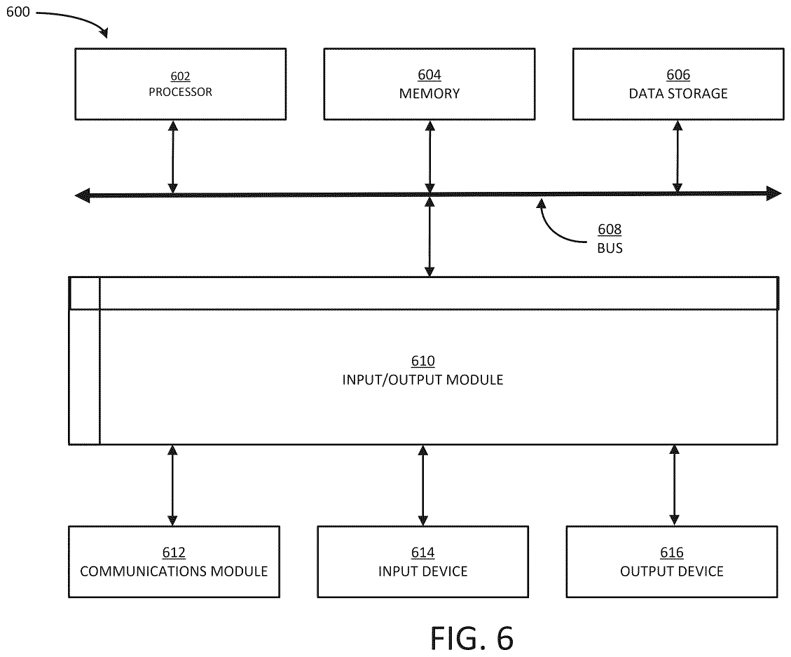

FIG. 6 is a block diagram illustrating an exemplary computer system with which client devices, and the methods and processes in FIGS. 3 and 5, may be implemented, according to some embodiments. In certain aspects, the computer system 600 may be implemented using hardware or a combination of software and hardware, either in a dedicated server, or integrated into another entity, or distributed across multiple entities.

Computer system 600 (e.g., client device(s) 110 and server(s) 130) may include bus 608 or another communication mechanism for communicating information, and a processor 602 (e.g., processors 212) coupled with bus 608 for processing information. By way of example, computer system 600 may be implemented with one or more processors 602. Processor 602 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that may perform calculations or other manipulations of information.

Computer system 600 may include, in addition to hardware, code that creates an execution environment for the computer program in question, e.g., code that constitutes processor firmware, a protocol stack, a database management system, an operating system, or a combination of one or more of them stored in an included memory 604 (e.g., memories 220), such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 608 for storing information and instructions to be executed by processor 602. Processor 602 and the memory 604 may be supplemented by, or incorporated in, special purpose logic circuitry.

The instructions may be stored in memory 604 and implemented in one or more computer program products, e.g., one or more modules of computer program instructions encoded on a computer-readable medium for execution by, or to control the operation of, computer system 600, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 604 may also be used for storing temporary variable or other intermediate information during execution of instructions to be executed by processor 602.

A computer program as discussed herein does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program may be deployed to be executed on one computer or on multiple computers that may be located at one site or distributed across multiple sites and interconnected by a communication network. The processes and logic flows described in this specification may be performed by one or more programmable processors executing one or more computer programs to perform functions by operating on input data and generating output.

Computer system 600 further includes a data storage device 606 such as a magnetic disk or optical disk, coupled to bus 608 for storing information and instructions. Computer system 600 may be coupled via input/output module 610 to various devices. Input/output module 610 may be any input/output module. Exemplary input/output modules 610 include data ports such as Universal Serial Bus (USB) ports. The input/output module 610 may be configured to connect to a communications module 612. Exemplary communications modules 612 (e.g., communications modules 218) include networking interface cards, such as Ethernet cards and modems. In certain aspects, input/output module 610 may be configured to connect to a plurality of devices, such as an input device 614 (e.g., input device 214) and/or an output device 616 (e.g., output device 216). Exemplary input devices 614 include a keyboard and a pointing device, e.g., a mouse or a trackball, by which a user may provide input to computer system 600. Other kinds of input devices 614 may be used to provide for interaction with a user as well, such as a tactile input device, visual input device, audio input device, or brain-computer interface device. For example, feedback provided to the user may be any form of sensory feedback, e.g., visual feedback, auditory feedback, or tactile feedback; and input from the user may be received in any form, including acoustic, speech, tactile, or brain wave input. Exemplary output devices 616 include display devices, such as an LCD (liquid crystal display) monitor, for displaying information to the user.

According to one aspect of the present disclosure, client device(s) 110 and server(s) 130 may be implemented using computer system 600 in response to processor 602 executing one or more sequences of one or more instructions contained in memory 604. Such instructions may be read into memory 604 from another machine-readable medium, such as data storage device 606. Execution of the sequences of instructions contained in memory 604 causes processor 602 to perform the process steps described herein. One or more processors in a multi-processing arrangement may also be employed to execute the sequences of instructions contained in memory 604. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification may be implemented in a computing system that includes a back-end component, e.g., a data server, or that includes a middleware component, e.g., an application server, or that includes a front-end component, e.g., a client computer having a graphical user interface or a Web browser through which a user may interact with an implementation of the subject matter described in this specification, or any combination of one or more such back-end, middleware, or front-end components. The components of the system may be interconnected by any form or medium of digital data communication, e.g., a communication network. The communication network (e.g., network 150) may include, for example, any one or more of a LAN, a WAN, the Internet, and the like. Further, the communication network may include, but is not limited to, for example, any one or more of the following tool topologies, including a bus network, a star network, a ring network, a mesh network, a star-bus network, tree or hierarchical network, or the like. The communications modules may be, for example, modems or Ethernet cards.

Computer system 600 may include clients and servers. A client and server may be generally remote from each other and typically interact through a communication network. The relationship of client and server arises by virtue of computer programs running on the respective computers and having a client-server relationship to each other. Computer system 600 may be, for example, and without limitation, a desktop computer, laptop computer, or tablet computer. Computer system 600 may also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 602 for execution. Such a medium may take many forms, including, but not limited to, non-volatile media, volatile media, and transmission media. Non-volatile media include, for example, optical or magnetic disks, such as data storage device 606. Volatile media include dynamic memory, such as memory 604. Transmission media include coaxial cables, copper wire, and fiber optics, including the wires forming bus 608. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer may read. The machine-readable storage medium may be a machine-readable storage device, a machine-readable storage substrate, a memory device, a composition of matter affecting a machine-readable propagated signal, or a combination of one or more of them.

To illustrate the interchangeability of hardware and software, items such as the various illustrative blocks, modules, components, methods, operations, instructions, and algorithms have been described generally in terms of their functionality. Whether such functionality is implemented as hardware, software, or a combination of hardware and software depends upon the particular application and design constraints imposed on the overall system. Skilled artisans may implement the described functionality in varying ways for each particular application.

### General Notes on Terminology

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the term “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No clause element is to be construed under the provisions of 35 U.S.C. § 112, sixth paragraph, unless the element is expressly recited using the phrase “means for” or, in the case of a method clause, the element is recited using the phrase “step for.”

While this specification contains many specifics, these should not be construed as limitations on the scope of what may be claimed, but rather as descriptions of particular implementations of the subject matter. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

The subject matter of this specification has been described in terms of particular aspects, but other aspects may be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims may be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems may generally be integrated together in a single software product or packaged into multiple software products. Other variations are within the scope of the following claims.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a configuration may refer to one or more configurations and vice versa.

In one aspect, unless otherwise stated, all measurements, values, ratings, positions, magnitudes, sizes, and other specifications that are set forth in this specification, including in the clauses that follow, are approximate, not exact. In one aspect, they are intended to have a reasonable range that is consistent with the functions to which they relate and with what is customary in the art to which they pertain. It is understood that some or all steps, operations, or processes may be performed automatically, without the intervention of a user. Method clauses may be provided to present elements of the various steps, operations, or processes in a sample order, and are not meant to be limited to the specific order or hierarchy presented.

Although illustrative embodiments have been shown and described, a wide range of modification, change, and substitution are contemplated in the foregoing disclosure and in some instances, some features of the embodiments may be employed without a corresponding use of other features. Those of ordinary skill in the art would recognize many variations, alternatives, and modifications. Thus, the scope of the invention should be limited only by the following claims, and it is appropriate that the claims be construed broadly and in a manner consistent with the scope of the embodiments disclosed herein.

What is claimed is:

1. A computer-implemented method, comprising:
generating, from a first type of image data associated with a first user, a first digital representation of the first user;
generating, from a second type of image data associated with a second user, a second digital representation of the second user;
determining a similarity score associated with a degree of correspondence between the first and the second digital representations;
determining, based on the similarity score, whether an identity of the first user matches an identity of the second user; and
allowing, based on determining the identity of the first user matches the identity of the second user, an access to an asset associated with the first user.

2. The computer-implemented method of claim 1, further comprising:
receiving, from at least one sensor including at least one camera associated with a first client device of the first user, the first type of image data; and
receiving, from at least one sensor including at least one camera associated with a second client device of the second user, the second type of image data.

3. The computer-implemented method of claim 2, wherein:
the first client device is the same as the second client device; and
at least one of the first client device and the second client device include a head-mounted display.

4. The computer-implemented method of claim 2, wherein:
the first client device is different from the second client device; and
at least one of the first client device and the second client device include a head-mounted display.

5. The computer-implemented method of claim 1, wherein:
the first type of image data includes at least one image of at least one physical feature of the first user;
the second type of image data includes at least one image of at least one physical feature of the second user; and
the first type of image data is different from the second type of image data.

6. The computer-implemented method of claim 1, wherein:
the first type of image data includes true-color image data; and
the second type of image data includes false-color image data.

7. The computer-implemented method of claim 1, wherein:
generating the first digital representation includes:
identifying, based on the first type of image data, one or more physical features of the first user, and
determining, based on the one or more physical features of the first user, the identity of the first user; and
generating the second digital representation includes:
identifying, based on the second type of image data, one or more physical features of the second user, and
determining, based on the one or more physical features of the second user, the identity of the second user.

8. The computer-implemented method of claim 1, wherein the asset associated with the first user includes a three-dimensional model of the first user displayed via a first client device of the first user or a second client device of the second user.

9. The computer-implemented method of claim 1, wherein determining the identity of the first user matches the identity of the second user includes determining the similarity score satisfies a similarity threshold.

10. The computer-implemented method of claim 1, further comprising:
denying, based on determining the identity of the first user differs from the identity of the second user, the access to the asset associated with the first user.

11. The computer-implemented method of claim 10, wherein determining the identity of the first user differs from the identity of the second user includes determining the similarity score fails to satisfy a similarity threshold.

12. A system, comprising:
one or more processors; and
a memory storing instructions that, when executed by the one or more processors, cause the system to perform operations including:
generating, from a first type of image data associated with a first user, a first digital representation of the first user;
generating, from a second type of image data associated with a second user, a second digital representation of the second user;
determining a similarity score associated with a degree of correspondence between the first and the second digital representations;
determining, based on the similarity score, whether an identity of the first user matches an identity of the second user; and
allowing, based on determining the identity of the first user matches the identity of the second user, an access to an asset associated with the first user.

13. The system of claim 12, wherein the operations further include:
receiving, from at least one sensor including at least one camera associated with a first client device of the first user, the first type of image data; and
receiving, from at least one sensor including at least one camera associated with a second client device of the second user, the second type of image data.

14. The system of claim 13, wherein:
the first client device is the same as the second client device, and at least one of the first client device and the second client device include a head-mounted display; or
the first client device is different from the second client device, and at least one of the first client device and the second client device include a head-mounted display.

15. The system of claim 12, wherein:
the first type of image data includes true-color image data and at least one image of at least one physical feature of the first user;
the second type of image data includes false-color image data and includes at least one image of at least one physical feature of the second user; and
the first type of image data is different from the second type of image data.

16. The system of claim 12, wherein:
generating the first digital representation includes:
identifying, based on the first type of image data, one or more physical features of the first user, and
determining, based on the one or more physical features of the first user, the identity of the first user; and
generating the second digital representation includes:
identifying, based on the second type of image data, one or more physical features of the second user, and
determining, based on the one or more physical features of the second user, the identity of the second user.

17. The system of claim 12, wherein the asset associated with the first user includes a three-dimensional model of the first user displayed via a first client device of the first user or a second client device of the second user.

18. The system of claim 12, wherein determining the identity of the first user matches the identity of the second user includes determining the similarity score satisfies a similarity threshold.

19. The system of claim 12, wherein the operations further include:
denying, based on determining the identity of the first user differs from the identity of the second user, the access to the asset associated with the first user, wherein determining the identity of the first user differs from the identity of the second user includes determining the similarity score fails to satisfy a similarity threshold.

20. A non-transitory computer-readable storage medium storing instructions encoded thereon that, when executed by a processor, cause the processor to perform operations comprising:
receiving, from at least one sensor including at least one camera associated with a first client device of a first user, a first type of image data including true-color image data;
receiving, from at least one sensor including at least one camera associated with a second client device of a second user, a second type of image data including false-color image data, wherein at least one of the first client device and the second client device include a head-mounted display;
generating, from the first type of image data associated with the first user, a first digital representation of the first user;
generating, from the second type of image data associated with the second user, a second digital representation of the second user;
determining a similarity score associated with a degree of correspondence between the first and the second digital representations;
determining, based on the similarity score, whether an identity of the first user matches an identity of the second user; and
allowing, based on determining the identity of the first user matches the identity of the second user, an access to a three-dimensional model of the first user displayed via the first client device or the second client device, wherein determining the identity of the first user matches the identity of the second user includes determining the similarity score satisfies a similarity threshold.
